(19) United States
(12) Patent Application Publication
(10) Pub. No.: US 2025/0023040 A1
(43) Pub. Date: Jan. 16, 2025

(54) CATHODE ACTIVE MATERIAL HAVING COMPOSITE COATING LAYER

(71) Applicant: L&F CO., LTD., Daegu (KR)

(72) Inventors: Da Jeong PARK, Daegu (KR); Jun Sung LEE, Daegu (KR); Jeong A GU, Daegu (KR); Sung Kyun CHANG, Daegu (KR)

(21) Appl. No.: 18/714,653

(22) PCT Filed: Dec. 1, 2022
(86) PCT No.: PCT/KR2022/019430

§ 371 Date: May 30, 2024

(30) Foreign Application Priority Data
Dec. 3, 2021 (KR) 10-2021-0171398
Dec. 3, 2021 (KR) 10-2021-0171410

(51) Int. Cl. H01M 4/525; H01M 4/02; H01M 4/36

(52) U.S. Cl. CPC H01M 4/525; H01M 4/366; H01M 2004/028

(57) ABSTRACT

Disclosed is a cathode active material including a one-body core containing lithium transition metal oxide, and a composite coating layer located on the one-body core, wherein the composite coating layer includes a crystalline coating part and an amorphous coating part.

### TECHNICAL FIELD

The present invention relates to a cathode active material including a composite coating layer, and more specifically, to a cathode active material including a one-body core and a composite coating layer including a crystalline coating part and an amorphous coating part, formed on the one-body core.

### BACKGROUND ART

Recently, lithium secondary batteries have been used in various fields such as mobile devices, energy storage systems, and electric vehicles.

Lithium secondary batteries have advantages of high energy density, high operation voltage, long lifespan, and low self-discharge compared to other secondary batteries. Requirements for lithium secondary batteries applied to electric vehicles and ESSs, large-capacity energy storage devices, include rapid charging, improved stability, high capacity and output characteristics.

Among the constituent materials of lithium secondary batteries, the cathode active material is the most important factor in satisfying the requirements as above. To solve this, methods such as adjusting the Ni content in the Li(NiCoMn)O₂ compound of the cathode active material, doping of internal transition metal oxide, and surface coating are performed.

Thereamong, surface coating affects the external surface performance rather than stabilizing the internal structure of the cathode active material, preventing direct contact with the electrolyte and preventing decomposition or oxidation of the electrolyte. In particular, physical parameters such as coating material, size, thickness, uniformity, density, and conductivity have a significant impact on the electrochemical performance of the cathode active material.

A variety of metal compound coating sources applied to conventional cathode active material coating include Al₂O₃, H₃BO₃, B₂O₃, WO₃, ZrO₂, Co₃O₄, phosphate compounds and the like. However, these materials mostly exist in an amorphous form on the surface of the cathode active material after coating, deteriorating resistance characteristics and failing to provide a desired level of lifespan characteristics. In addition, these materials do not provide the high-temperature characteristics necessary for stable use over a long period of time at high temperatures, such as electric vehicles and ESSs.

Meanwhile, cathode active materials generally used in lithium secondary batteries have a secondary particle structure of several m in size where submicron-size fine primary particles are aggregated. The secondary particle structure has a problem in that battery characteristics deteriorate as the secondary particles break as the aggregated primary particles are separated during repeated charging and discharging. This problem is due to the structural characteristics of secondary particles and is thus difficult to solve without changing the structure. Therefore, a one-body cathode active material with a novel structure was developed.

Unlike conventional secondary particles, single particles of one-body cathode active materials have a size of several μm and do not have an aggregated structure, thus causing no particle separation during charging and discharging, and fundamentally solving problems arising from the secondary particle structure.

However, one-body cathode active materials require high-temperature calcination conditions during the synthesis process. During this process, a problem in which oxygen required to form a crystal structure is not adsorbed and desorbed occurs. As a result, the surface structure of the one-body cathode active material exists in the form of rock-salt, which acts as a resistance during intercalation and deintercalation of lithium and deteriorates lifespan characteristics.

As explained above, this phenomenon becomes serious in cathode active materials with increased Ni content among transition metals in order to increase battery requirements, and is one of the fundamental factors preventing the commercialization of Ni-based one-body active materials.

### DISCLOSURE

### Technical Problem

Therefore, the present invention has been made to solve the above and other technical problems that have yet to be solved.

Therefore, as a result of extensive research and various experiments, the present inventors developed a cathode active material having a novel structure in which a specific composite coating layer including a crystalline coating part and an amorphous coating part is located on a one-body core, and found that this cathode active material does not cause particle separation during charging and discharging, improves resistance characteristics, and increases initial capacity and lifespan characteristics through effects of providing structural stability, reducing lithium by-products, and suppressing side reactions with electrolyte solutions.

### Technical Solution

In accordance with an aspect of the present invention, provided is a cathode active material including a one-body core containing lithium transition metal oxide and a composite coating layer located on the one-body core, wherein the composite coating layer includes a crystalline coating part and an amorphous coating part.

As explained above, the oxygen desorption that occurs during the calcination process for producing the cathode active material is not a major problem in the cathode active material in the form of secondary particles where primary particles are aggregated, but causes a serious problem in one-body (particle) cathode active materials.

Specifically, oxygen desorption produces an excessive amount of NiO having an electrochemically inactive rock salt structure in the layered structure of the cathode active material and increases Li by-products. Therefore, NiO gradually increases due to repeated charging and discharging, resulting in higher resistance. As Li by-products increase, various side reactions occur, resulting in deterioration of battery performance such as capacity reduction.

Although the cathode active material of the present invention is based on a one-body (one-body particle) core, these problems are solved by the composite coating layer including the crystalline coating part and the amorphous coating part.

Constituent elements of the composite coating layer according to the present invention carry a large amount of oxygen (O) while diffusing and moving toward the one-body core at a high calcination temperature. Therefore, oxygen is supplied into the one-body particle core and induces recombination of Li and oxygen, thus reducing oxygen desorption on the particle surface.

However, it is very difficult to apply the crystalline coating to the entire surface of the particle and internal resistance may increase during the process of forming it. Therefore, partial application may be preferable. For this reason, there is present an outer surface of the one-body particle core to which the crystalline coating part is not applied, which may cause side reactions due to exposure to the electrolyte. Therefore, the composite coating layer according to the present invention includes an amorphous coating part in addition to the crystalline coating part to solve this problem.

Therefore, in the composite coating layer of the present invention, the crystalline coating part improves the initial resistance characteristics and lifespan characteristics through rearrangement of the structure, and the amorphous coating part is applied to the entire remaining outer surface of the one-body particle core to suppress electrolyte side reactions due to contact with the one-body particle core.

In one specific example, the one-body particle core of the cathode active material of the present invention may be a lithium transition metal oxide containing Ni, and the Ni content may be 60 mol % or more, at which oxygen desorption increases during the calcination process, more particularly 80% or higher at which oxygen desorption significantly increases during the calcination process.

The one-body particle core may vary depending on the Ni content, but may generally be produced by calcination at a high temperature of 700 to 1,000° C. As the Ni content increases, the calcination temperature decreases.

In a specific embodiment, the one-body particle core may include a composition of Formula 1 below:

LiₐNi_{b}Co_{c}Mn_{d}DₑOₓ (1)
wherein a, b, c, d, e and x satisfy 0.95≤a≤1.1, 0<b≤1, 0≤c<1, 0≤d<1, 0≤e≤0.05, and 0<x≤4, respectively, and
D includes at least one of Ti, Zr, Al, P, Si, B, W, Mg, and Sn.

Preferably, the Ni content (b) may be 0.6 or more.

As can be seen from subsequent experiments, the crystalline coating part may be distributed in an island type on the outer surface of the one-body particle core.

The island-shaped area may include only a crystalline coating part, but may also have a structure in which the crystalline coating part and an amorphous coating part coexist. Specifically, the island-shaped area may have a structure in which the crystalline coating part is located on the inner side, that is, toward the one-body particle core and the amorphous coating part is located on its outer surface, that is, in the outer direction. Even in this case, the size of the crystalline coating part in the island-shaped area is relatively larger than that of the amorphous coating part, for example, the crystalline coating part may be thicker than the amorphous coating part.

As previously defined, the crystalline coating part acts to improve initial resistance characteristics and lifetime characteristics by rearrangement of the surface structure and this effect can be realized by reduced cation mixing, reduced lithium by-products, and increased Li ion migration pathway.

Cation mixing indicates the degree of mixing of Li ions with Ni ions. When the degree is large, the surface of the cathode active material is present in an irreversible phase of Fd-3m rock salt structure and interferes with the movement of lithium ions during the charging and discharging of lithium secondary batteries, causing permanent capacity loss, and deteriorating rate and lifespan characteristics.

There are two reasons for cation mixing.

First, the synthesis of one-body particle active materials is performed at a high temperature. At this time, Ni³⁺ is easily reduced to Ni²⁺ thermodynamically. In this high-temperature environment, Li as a raw material volatilizes, thus causing Li deficiency because Ni²⁺ exists in the hole where Li⁺ should exist.

Second, when one-body particle active materials are applied to a lithium secondary battery and are repeatedly charged and discharged, Li ions escape from the cathode active material structure during charging and lattice expansion facilitates the movement of ions. At this time, Ni²⁺ exists at the Li site because Li ions cannot return to the original site thereof.

Accordingly, the crystalline coating part of the present invention rearranges the surface structure, that is, converts the inert rock-salt structure of the surface into a structure capable of moving lithium ions, thereby improving initial resistance characteristics and lifespan characteristics.

In one specific example, the crystalline coating part may include a transition metal compound whose outermost electron is located in the 3d orbital of the electron configuration among the elements on the periodic table.

Such a transition metal preferably includes at least one selected from Co, Mn, Ti, and Zr. For example, Co has the electronic configuration of [Ar] 4S²3d⁷, Mn has the electronic configuration of [Ar] 4S²3d⁵, and Ti has the electronic configuration of [Ar] 4S²3d².

The crystalline coating part may contain a transition metal oxide (a), or may contain lithium transition metal oxide (b1) and transition metal oxide (b2) produced by reaction of the transition metal oxide (a) and lithium by-product. Due to the presence or absence of reaction with lithium by-products, the transition metal oxide (a) and the transition metal oxide (b2) may have slightly different chemical compositions. In some cases, the crystalline coating part may contain all of transition metal oxide (a), lithium transition metal oxide (b1), and transition metal oxide (b2).

Based on cobalt (Co) as a typical example of the transition metal, transition metal oxide (a), lithium transition metal oxide (b1), transition metal oxide (b2), or the like will be described.

Regarding Co, a coating material, for example, Co(OH)₂ may be added to the outer surface of the one-body core. The melting point of Co(OH)₂ is 168° C. and may be converted to CoO₂ in a vacuum atmosphere in accordance with the following Reaction Scheme:

Co(OH)₂→CoO₂+H₂↑

In an air or O₂ atmosphere at 300° C. or higher, Co(OH)₂ may be converted to Co₃O₄ in accordance with the following Reaction Scheme:

3Co(OH)₂+½O₂→Co₃O₄+3H₂O

Co₃O₄ is the transition metal oxide (a) described above and reacts with lithium by-products, that is, LiOH and Li₂CO₃, generated during the synthesis of the cathode active material, in the high-temperature heat treatment process for forming the composite coating layer, to form LiCoO₂ as lithium transition metal oxide (b1), and CoO as transition metal oxide (b2).

Therefore, the crystalline coating part in the composite coating layer may include a single crystalline layered structure with the formula xLiCoO₂+yCoO (x>0, y>0, x+y≤1), and may further include Co₃O₄ if the equation of x+y<1 is satisfied. Depending on the conditions for forming the composite coating layer, this crystalline and spinel structure may exist simultaneously.

As a result, in the process of forming the crystalline coating part, lithium by-products are significantly reduced, and cation mixing is suppressed by the crystalline coating part, thereby increasing the movement pathway of Li ions, which provides the effect of reducing initial resistance.

Generally, Ni-based one-body active materials, which contain Ni as a main component among transition metals, contain Mn to improve lifespan characteristics. As the Ni content increases, the content of Mn that may be contained relatively decreases, which reduces structural stability and thus lifespan.

During charging and discharging, the crystal structure of secondary batteries contracts and expands, and the gap between the O (oxygen) layers becomes closer and farther apart. As this process is repeated, the crystal structure is deformed/collapsed, thus deteriorating the lifespan characteristics. By maintaining the spacing between O (oxygen) layers during charging and discharging, it is possible to prevent the crystal structure from being deformed/collapsed.

In the composite coating layer of the present invention, the amorphous coating part suppresses electrolyte side reactions as described above, and improves structural stability, thus increasing the lifespan characteristics because it contains an element having a very large bond-dissociation energy (BDE) with O (oxygen).

Therefore, in a specific example, the amorphous coating part may include a compound of a metalloid or nonmetal (‘metalloid/nonmetal’) whose outermost electrons are located in the p orbital of the electronic configuration among the elements on the periodic table.

In non-limiting examples, examples of the metalloid include boron (B), silicon (Si) and the like, and examples of the nonmetal include carbon (C) and the like.

The amorphous coating part contains a metalloid/non-metal compound (c), or a metalloid/non-metal oxide (d1) and lithium oxide (d2) produced by reaction of the metalloid/non-metal compound (c) and a lithium by-product, or lithium metalloid/non-metal oxide (e).

In some cases, the amorphous coating part may contain all of a metalloid/non-metal compound (c), a metalloid/non-metal oxide (d1), lithium oxide (d2), and a lithium metalloid/non-metal oxide (e).

Based on boron (B), a typical example of the metalloid, the metalloid/nonmetal compound (c), metalloid/nonmetal oxide (d1), lithium oxide (d2), and lithium metalloid/nonmetal oxide (e) will be described.

Regarding B, a coating material, for example, B₂O₃ or H₃BO₃ may be added to the outer surface of the one-body core. H₃BO₃ has a melting point of 170° C. and may be converted to HBO₂ at a temperature lower than 450° C., the melting point of B₂O₃, in accordance with the following Reaction Scheme:

H₃BO₃→HBO₂+H₂O (170° C.)

In addition, H₃BO₃ may be converted to B₂O₃ at 300° C. or higher in accordance with the following Reaction Scheme.

2HBO₂→B₂O₃+H₂O (300° C.)

B₂O₃ or H₃BO₃ is a metalloid/non-metal compound (c), which is an ion conductor with a 3D network and improves structural stability through a strong B—O bond with high chemical stability. For reference, the bond-dissociation energy (BDE) of B and O is 806 kJ/mol, which is much higher than 368 kJ/mol of the BDE of Co which is a typical element of the crystalline coating part and O, the BDE of Si which is other metalloid/nonmetal and O is 798 kJ/mol, and the BDE of C and O is 1,076.5 kJ/mol, which is higher than the BDE of Co and O.

The metalloid/non-metal compound (c) may react with LiOH, Li₂CO₃, or the like, which are lithium by-products, to produce B₂O₃, which is a metalloid/non-metal oxide (d1), and Li₂O, which is lithium oxide (d2). Here, the metalloid/non-metal oxide (d1) and lithium oxide (d2) may include an amorphous structure having the formula xB₂O₃+yLi₂O (x>0, y>0, x+y≤1), and may produce Li₃BO₃, a lithium metalloid/non-metal oxide (e), as an intermediate phase, if x+y<1 through the interaction.

Here, the improvement in ionic conductivity increases as the content of Li₂O increases, but an appropriate combination with B₂O₃ may be required. Li₃BO₃ has high ionic conductivity and acts as an ion conductor at the interface of lithium metal compounds, increasing the movement of lithium ions and achieving high initial capacity. In addition, Li₃BO₃ acts as a cathode electrolyte interphase (CEI) to stabilize the interface surface structure, suppressing side reactions with the electrolyte solution during the oxidation-reduction process of lithium ions and providing excellent lifespan performance.

In some cases, the amorphous coating part may further contain a tungsten-based compound to improve high-temperature characteristics.

The tungsten-based compound (f) may also include lithium tungsten oxide (g) produced by reaction with a lithium by-product.

That is, the amorphous coating part may further contain at least one of a tungsten-based compound (f), and lithium tungsten oxide (g) generated by the reaction of the tungsten-based compound (f) and a lithium by-product.

W is the main element that constitutes the tungsten-based compound, and the bond-dissociation energy (BDE) of W and O is 653 kJ/mol, which is about twice 368 kJ/mol, the BDE of Co which is a typical element of the crystalline coating part and O. Therefore, W can improve structural stability and high temperature lifespan/resistance characteristics when used in combination with the B. Typical examples of such compounds include tungsten oxide such as WO₃.

WO₃, a tungsten-based compound (f) added as a coating material, may react with Li₂CO₃ and LiOH present on the surface of the one-body core in the coating temperature range of 400° C. to produce lithium tungsten oxide (g) having an amorphous structure. The lithium tungsten oxide has the effects of lowering initial resistance and increasing initial capacity due to its high ionic conductivity of 2,446 μS/cm. In addition, WO₃, a coating material, is decomposed by oxidation-reduction reaction with the electrolyte and is deposited or adsorbed to form an SEI (solid electrolyte interface) layer, which allows lithium ions to pass through, but reduces the movement of electrons. This SEI layer suppresses electrolyte decomposition due to electron transfer between the active material and the electrolyte, and enables selective intercalation and deintercalation of lithium ions, resulting in a low resistance increase rate during repeated charge and discharge cycles, especially in a high temperature environment.

As can be seen from the subsequent experimental results, when the amorphous coating part includes both a metalloid/nonmetal and tungsten, high temperature characteristics as well as the overall electrochemical properties are improved compared to when the amorphous coating part includes only a metalloid/nonmetal. It is considered that the action of tungsten has some influence on the action of metalloids/nonmetals.

As described above, the crystalline coating part mainly contains transition metals, but in some cases, the crystalline coating part may also contain metalloids and/or non-metals. In this case, the content of the transition metals exceeds 50% on a molar basis. An example of this can be seen from the island-type area described above. When the crystalline coating part further contains tungsten, the content of the transition metal also exceeds 50% on a molar basis.

Similarly, the amorphous coating part primarily contains metalloids and/or non-metals. However, in some cases, the amorphous coating part may also contain a transition metal. The total metalloid/non-metal content exceeds 50% on a molar basis. As described above, when the amorphous coating part further contains tungsten, the total content of metalloid/nonmetal and tungsten exceeds 50% on a molar basis.

The present invention also provides a secondary battery including the cathode active material described above.

Other anode active materials, separators, electrolytes and electrolyte solutions that constitute secondary batteries, and methods of manufacturing the same are known in the art, and thus a detailed description thereof will be omitted herein.

### Effects of the Invention

As described above, the cathode active material for secondary batteries according to the present invention includes a composite coating layer including a crystalline coating part and an amorphous coating part located on a one-body core, thereby avoiding particle separation during charging and discharging, and improving resistance characteristics, initial capacity and life characteristics through effects of providing structural stability, reducing lithium by-products, and suppressing side reactions with the electrolyte solution, and in some cases, improving high temperature characteristics.

### DESCRIPTION OF THE DRAWINGS

FIG. 1 is an SEM image showing a cathode active material of Example 1 obtained in Experimental Example 3;

FIG. 2 is a TEM image showing a cathode active material of Comparative Example 1 obtained in Experimental Example 4;

FIGS. 3A to 3D are TEM images showing the cathode active material of Example 1 obtained in Experimental Example 4; and

FIGS. 4A to 4D are images showing the lattice shape of the coating layer structure obtained through FFT (fast Fourier transform) analysis based on the TEM analysis obtained in Experimental Example 4.

### BEST MODE

Now, the present invention will be described in more detail with reference to the following examples. These examples should not be construed as limiting the scope of the present invention.

### <Reference Example 1> Precursor with Ni Co Mn Ratio of 78:10:12

NiSO₄ as a nickel raw material, CoSO₄ as a cobalt raw material, and MnSO₄ as a manganese raw material were used. These raw materials were dissolved in distilled water in a 1,000 L cylindrical reactor to prepare a metal salt aqueous solution with a ratio of Ni, Co and Mn of 78:10:12

After a coprecipitation reactor was prepared, an aqueous metal salt solution and an aqueous ammonia solution (chelating agent) were added to the coprecipitation reactor, the pH in the reactor was adjusted to 10 to 12, and the ammonia concentration in the reactor was adjusted to 3,000 to 6,000 ppm. The temperature of the reactor was maintained at 50 to 60° C. and the reaction time was 30 hours.

After the coprecipitation reaction, the precipitate synthesized according to the coprecipitation process was filtered and dried at 120° C. for 24 hours to prepare a cathode active material precursor with a D50 of 2.5 to 3.0 μm. The composition of the prepared precursor was (Ni_{0.78}Co_{0.10}Mn_{0.12})(OH)₂ and the average particle diameter (D50) thereof was 4 to 6 μm.

### <Reference Example 2> Precursor with Ni Co Mn Ratio of 80:10:10

A cathode active material precursor was prepared in substantially the same manner as in Reference Example 1 except that the content ratio of Ni, Co, and Mn was 80:10:10.

### <Reference Example 3> Precursor with Ni Co Mn Ratio of 95:2.5:2.5

A cathode active material precursor was prepared in substantially the same manner as in Reference Example 1 except that the content ratio of Ni, Co, and Mn was 95:2.5:2.5.

### <Comparative Example 1> Cathode Active Material with Ni Co Mn Ratio of 78:10:12

Based on 1 mol of the cathode active material precursor prepared in Reference Example 1, 1.03 mole of LiOH·H₂O (SQM), 0.003 mole of Al(OH)₃, and 0.0020 mole of Co(OH)₂ were mixed using a P-Henschel mixer at 52 Hz for 20 minutes to prepare a mixture. Then, the mixture was applied into an RHK (roller hearth kiln), calcined in the presence of oxygen at 900° C. or higher, and then cooled to room temperature. Then, the calcined product was pulverized using D-ACM as a pulverizer to prepare a cathode active material with D50 of 5 to 6 μm.

### <Comparative Example 2> Cathode Active Material with Ni Co Mn Ratio of 80:10:10

A cathode active material was prepared in subsequently the same manner as in Comparative Example 1 using the cathode active material precursor prepared in Reference Example 2, except that the calcination temperature was not lower than 850° C. and not higher than 900° C.

### <Comparative Example 3> Cathode Active Material with Ni Co Mn Ratio of 95:2.5:2.5

A cathode active material was prepared in subsequently the same manner as in Comparative Example 1 using the cathode active material precursor prepared in Reference Example 3, except that the calcination temperature was not lower than 800° C. and not higher than 850° C.

### <Comparative Example 4> H₃BO₃-Only Coating of Cathode Active Material with Ni_{0.78}Co_{0.10}Mn_{0.12} Composition

A H₃BO₃ coating material was added to the cathode active material prepared in Comparative Example 1, and mixed in a 50 L P-Henschel mixer at 52 Hz for 30 minutes to prepare a mixture. Then, the mixture was applied into RHK, calcined at a temperature of 300° C. or lower while maintaining oxygen, and then cooled to room temperature to prepare a coated cathode active material. The prepared cathode active material has an amorphous coating layer formed on the surface.

### <Comparative Example 5> H₃BO₃-Only Coating of Cathode Active Material with Ni_{0.80}Co_{0.10}Mn_{0.10} Composition

The same coating as in Comparative Example 4 was performed using the cathode active material prepared in Comparative Example 2.

### <Comparative Example 6> H₃BO₃-Only Coating of Cathode Active Material with Ni_{0.95}Co_{0.025}Mn_{0.025} Composition

The same coating as in Comparative Example 4 was performed using the cathode active material prepared in Comparative Example 3.

### <Comparative Example 7> Co(OH)₂-Only Coating of Cathode Active Material with Ni_{0.78}Co_{0.10}Mn_{0.12} Composition

A Co(OH)₂ coating material was added to the cathode active material prepared in Comparative Example 1, and mixed in a 50 L P-Henschel mixer at 52 Hz for 30 minutes to prepare a mixture. Then, the mixture was applied into RHK, calcined at a temperature of 700° C. or lower while maintaining oxygen, and then cooled to room temperature to prepare a coated cathode active material. The prepared cathode active material has a crystalline coating layer formed on the surface thereof.

### <Comparative Example 8> Co(OH)₂-Only Coating of Cathode Active Material with Ni_{0.80}Co_{0.10}Mn_{0.10} Composition

The same coating as in Comparative Example 7 was performed using the cathode active material prepared in Comparative Example 2.

### <Comparative Example 9> Co(OH)₂-Only Coating of Cathode Active Material with Ni_{0.95}Co_{0.025}Mn_{0.025} Composition

The same coating as in Comparative Example 7 was performed using the cathode active material prepared in Comparative Example 3.

### <Example 1> H₃BO₃+Co(OH)₂ Composite Coating of Cathode Active Material with Ni_{0.78}Co_{0.10}Mn_{0.12} Composition

A coating material containing H₃BO₃ and Co(OH)₂ at a molar ratio of 1:6.5 was added to the cathode active material prepared in Comparative Example 1, and mixed in a 50 L P-Henschel mixer at 52 Hz for 30 minutes to prepare a mixture. Then, the mixture was applied into an RHK, calcined at a temperature of 300° C. or lower while maintaining oxygen, and then cooled to room temperature to prepare a coated cathode active material. This composite coating layer has both a crystalline area and an amorphous area.

### <Example 2> H₃BO₃+Co(OH)₂ Composite Coating of Cathode Active Material with Ni_{0.80}Co_{0.10}Mn_{0.10} Composition

A coating material containing H₃BO₃ and Co(OH)₂ at a molar ratio of 1:6.5 was added to the cathode active material prepared in Comparative Example 2 and then the same coating as in Example 1 was performed.

### <Example 3> H₃BO₃+Co(OH)₂ Composite Coating of Cathode Active Material with Ni_{0.95}Co_{0.025}Mn_{0.025} Composition

A coating material containing H₃BO₃ and Co(OH)₂ at a molar ratio of 1:6.5 was added to the cathode active material prepared in Comparative Example 3 and then the same coating as in Example 1 was performed.

### <Example 4> H₃BO₃+Co(OH)₂ Composite Coating of Cathode Active Material with Ni_{0.78}Co_{0.10} Mn_{0.12} Composition

A coating material containing H₃BO₃ and Co(OH)₂ at a molar ratio of 1:13 was added to the cathode active material prepared in Comparative Example 1 and then the same coating as in Example 1 was performed.

### <Example 5> H₃BO₃+Co(OH)₂ Composite Coating of Cathode Active Material with Ni_{0.80}Co_{0.10}Mn_{0.10} Composition

A coating material containing H₃BO₃ and Co(OH)₂ at a molar ratio of 1:13 was added to the cathode active material prepared in Comparative Example 2 and then the same coating as in Example 1 was performed.

### <Example 6> H₃BO₃+Co(OH)₂ Composite Coating of Cathode Active Material with Ni_{0.95}Co_{0.025}Mn_{0.025} Composition

A coating material containing H₃BO₃ and Co(OH)₂ at a molar ratio of 1:13 was added to the cathode active material prepared in Comparative Example 3 and then the same coating as in Example 1 was performed.

### <Example 7> B₂O₃+Co(OH)₂ Composite Coating of Cathode Active Material with Ni_{0.78}Co_{0.10}Mn_{0.12} Composition

A coating material containing B₂O₃ and Co(OH)₂ at a molar ratio of 1:6.5 was added to the cathode active material prepared in Comparative Example 1 and then the same coating as in Example 1 was performed, except that the calcination was performed at a temperature of 400° C. or less.

### <Example 8> B₂O₃+Co(OH)₂ Composite Coating of Cathode Active Material with Ni_{0.80}Co_{0.10}Mn_{0.10} Composition

A coating material containing B₂O₃ and Co(OH)₂ at a molar ratio of 1:6.5 was added to the cathode active material prepared in Comparative Example 2 and then the same coating as in Example 7 was performed.

### <Example 9> B₂O₃+Co(OH)₂ Composite Coating of Cathode Active Material with Ni_{0.95}Co_{0.025}Mn_{0.025} Composition

A coating material containing B₂O₃ and Co(OH)₂ at a molar ratio of 1:6.5 was added to the cathode active material prepared in Comparative Example 3 and then the same coating as in Example 7 was performed.

### <Example 10> B₂O₃+Co(OH)₂+WO₃ Composite Coating of Cathode Active Material with Ni_{0.78}Co_{0.10}Mn_{0.12} Composition

A coating material containing B₂O₃, Co(OH)₂ and WO₃ at a molar ratio of 1:2:2 was added to the cathode active material prepared in Comparative Example 1, and mixed in a 50 L P-Henschel mixer at 52 Hz for 30 minutes to prepare a mixture. Then, the mixture was applied into an RHK, calcined at a temperature of 400° C. or lower while maintaining oxygen, and then cooled to room temperature to prepare a cathode active material coated with a composite material containing B₂O₃, Co(OH)₂, and WO₃. The composite coating layer has both a crystalline coating area and an amorphous coating area.

### <Example 11> B₂O₃+Co(OH)₂+WO₃ Composite Coating of Cathode Active Material with Ni_{0.80}Co_{0.10}Mn_{0.10} Composition

The same coating as in Example 1 was performed using the cathode active material prepared in Comparative Example 2.

### <Example 12> B₂O₃+Co(OH)₂+WO₃ Composite Coating of Cathode Active Material with Ni_{0.95}Co_{0.025}Mn_{0.025} Composition

The same coating as in Example 1 was performed using the cathode active material prepared in Comparative Example 3.

### <Experimental Example 1> XRD (X-Ray Diffraction) Test

For the cathode active materials prepared in Examples 1 to 3 and 10 and Comparative Examples 1 to 3, the lattice constant was measured by X-ray diffraction using Cu Ka line. The measured a-axis and c-axis lengths and the distance between crystal sides (c/a axis ratio) are shown in Table 1 below. In addition, the full width at half maximum and crystallite size of the cathode active materials were measured and shown, and the R factor indicating growth degree of the hexagonal structure of the cathode active material was also calculated.

TABLE 1

| | | | | | | (003) | R | Crystallite | |
|---|---|---|---|---|---|---|---|---|---|
| Sample | A | c | c/a | Volume | (003)/(104) | FWHM | factor | size (Å) | [symbol] |
| Comparative | 2.8735 | 14.2085 | 4.9447 | 101.5989 | 1.5852 | 0.040 | 0.6448 | 284 | [symbol] |
| Example 1 | | | | | | | | | [symbol] |
| Comparative | 2.8739 | 14.2090 | 4.9441 | 101.6367 | 1.6589 | 0.042 | 0.6542 | 254 | [symbol] |
| Example 2 | | | | | | | | | [symbol] |
| Comparative | 2.8737 | 14.2081 | 4.9442 | 101.6125 | 1.6878 | 0.045 | 0.6489 | 213 | [symbol] |
| Example 3 | | | | | | | | | [symbol] |
| Example 1 | 2.8739 | 14.2096 | 4.9444 | 101.6369 | 1.7457 | 0.036 | 0.4088 | 340 | [symbol] |
| Example 2 | 2.8745 | 14.2100 | 4.9434 | 101.6851 | 1.6215 | 0.040 | 0.4236 | 295 | [symbol] |
| Example 3 | 2.8737 | 14.2084 | 4.9442 | 101.6182 | 1.7662 | 0.039 | 0.4565 | 256 | [symbol] |
| Example 10 | 2.8740 | 14.2086 | 4.9439 | 101.6370 | 1.6709 | 0.030 | 0.5013 | 427 | [symbol] |

[symbol]

indicates data missing or illegible when filed

As can be seen from Table 1, Comparative Examples 1 to 3 had a high Ni²⁺ level because there was no coating layer on the surface of the cathode active material. The level of Ni²⁺ increases in the order of Comparative Example 3>Comparative Example 2>Comparative Example 1, because the Ni content of the cathode active material increases, the amount of Ni²⁺ in the Li site increases during synthesis.

On the other hand, Examples 1 to 3 and 10 had a reduced level of Ni²⁺ compared to Comparative Examples 1 to 3 because Examples 1 to 3 and 10 have a composite coating layer in which a crystalline coating part and an amorphous coating part coexist on the surface of the cathode active material and the surface structure is rearranged due to the influence of the crystalline coating part and thus reduced presence of Ni²⁺ at the Li site.

FWHM is another parameter indicating successful surface structure rearrangement. FWHM represents full width at half maximum. As FWHM decreases, the grain size increases, indicating that crystallization has progressed better. As the surface of the cathode active material includes a composite coating layer of the crystalline coating part, initial resistance and lifespan characteristics can be improved when applied to a lithium secondary battery.

### <Experimental Example 2> Identification of Lithium by-Products

Lithium by-products were measured as follows. The equipment used for measurement was produced by Metrohm and sample pretreatment was performed by stirring 30±0.01 g of the sample and 100 g of distilled water in a beaker containing a magnetic bar for 30 minutes. Then, the stirred sample was naturally filtered through filter paper while care was taken to ensure that all of the sample was filtered. Then, 60±0.01 g of the filtrate was weighed and titration was started.

The amounts of lithium by-products of the cathode active materials of Examples 1 to 9 and Comparative Examples 1 to 9 are shown in Table 2 below.

TABLE 2

| | Li by- |
|---|---|
| Sample | product |
| Comparative Example 1 | 0.242 |
| Comparative Example 2 | 0.351 |
| Comparative Example 3 | 0.541 |
| Comparative Example 4 | 0.232 |
| Comparative Example 5 | 0.349 |
| Comparative Example 6 | 0.520 |
| Comparative Example 7 | 0.169 |
| Comparative Example 8 | 0.268 |
| Comparative Example 9 | 0.339 |
| Example 1 | 0.152 |
| Example 2 | 0.223 |
| Example 3 | 0.356 |
| Example 4 | 0.122 |
| Example 5 | 0.211 |
| Example 6 | 0.320 |
| Example 7 | 0.155 |
| Example 8 | 0.229 |
| Example 9 | 0.320 |

The weight of lithium by-product corresponds to the total weight of Li₂CO₃ and LiOH present on the surface of the cathode active material. When Li⁺ is not present at the site during calcination due to Ni²⁺ generation, as described in Table 1, it reacts with CO₂ present in the air during the heat treatment to produce Li₂CO₃ or reacts with water to produce LiOH.

In Table 2, when comparing Comparative Examples with Examples in terms of cathode active materials having the same Ni content, Examples 1 to 9 having a composite coating layer including both the crystalline coating part and the amorphous coating part exhibited low levels of lithium by-product compared to Comparative Examples 1 to 3 in which no coating layer was present and Comparative Examples 4 to 9 in which a single coating layer was present.

### <Experimental Example 3> SEM Analysis of Cathode Active Material

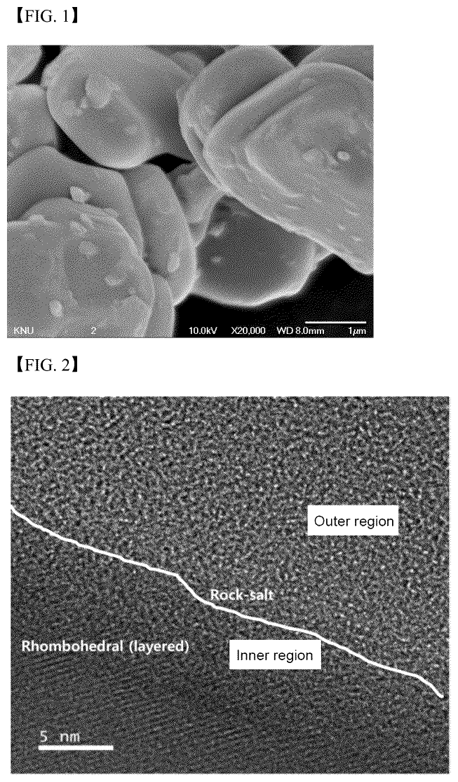

SEM analysis was performed on the cathode active material prepared in Example 1 and is shown in FIG. 1.

As can be seen from the SEM image (Example 1) of FIG. 1, a large number of small particles exist on the particle surface and the crystalline coating has an island-shaped distribution. An amorphous coating part may be applied to areas where such an island-type crystalline coating part does not exist and the amorphous coating part may be added to part or all of the outer surface of the crystalline coating part.

### <Experimental Example 4> TEM Analysis—Analysis of Coating Layer on the Surface of Cathode Active Material

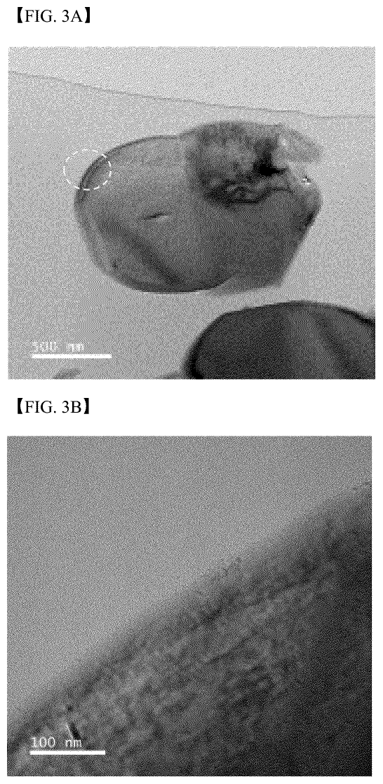

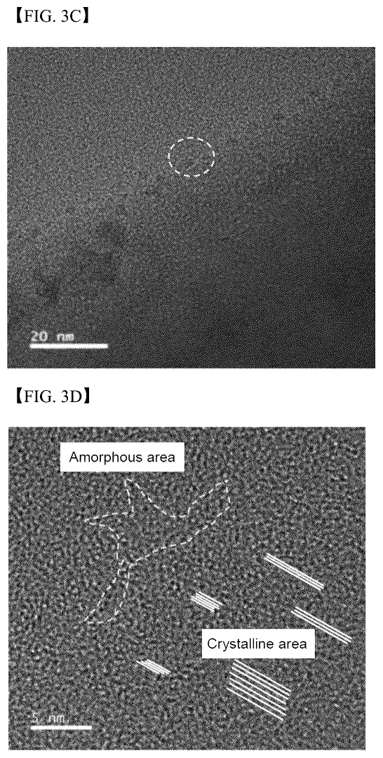

TEM (transmission electron microscopy) structural analysis was performed on the cathode active materials prepared in Comparative Example 1 and Example 1, and the results are shown in FIGS. 2 and 3A to 3D.

First, as shown in FIG. 2, the inner region of Comparative Example 1 has a regular pattern as an active material portion, showing a rhombohedral (layered) layered crystal structure. During the synthesis of cathode active materials, a deficiency phenomenon occurs due to volatilization of lithium salt during high-temperature calcination. The part marked “Rock salt” on the outer surface has a Fd-3m rock salt structure formed by cation mixing of Ni²⁺ in the empty Li holes in the structure.

On the other hand, as shown in FIGS. 3A to 3D, an amorphous coating part and a crystalline coating part coexist in the cathode active material of Example 1, without such a rock salt structure.

More specifically, FIG. 3A is a TEM image of the entire single particle, FIG. 3B is an enlarged image of the surface coating part of the single particle (yellow dotted circle in FIG. 3A) at 100 nm scale, FIG. 3C is an enlarged image at 20 nm scale and FIG. 3D is an enlarged image of the area of the yellow dotted circle in the surface layer in FIG. 3C, wherein the crystalline coating part, which is a crystalline area, is located in the one-body core (inward direction) at the bottom right, and the amorphous coating part is located on the outer surface of the particle (outward direction) at the top left.

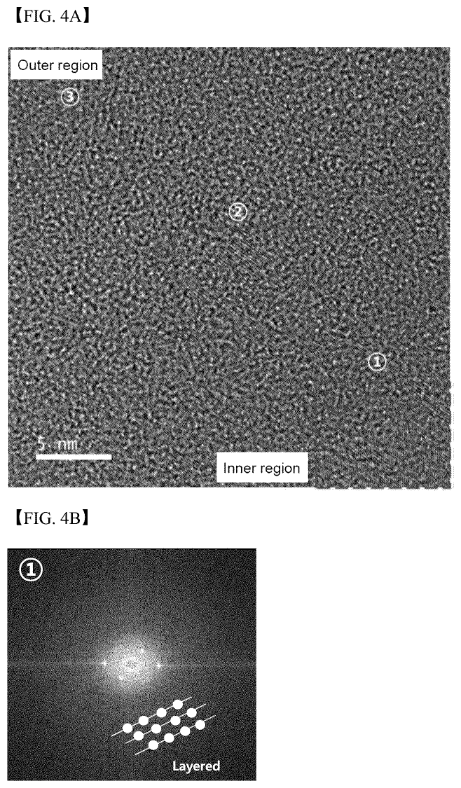

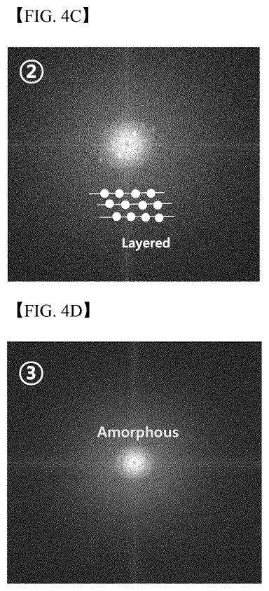

In addition, the coating layer present on the surface of the cathode active material of Example 1 was observed in an enlarged manner, and the results are shown in FIGS. 4A to 4D. In FIG. 4A, for points \textcircled{1}, \textcircled{2}, and \textcircled{3}, the diffraction point of a specific crystal plane is selected from the diffraction information in the inverse space that can be obtained by FFT (Fast Fourier transform) of the high-resolution TEM image, and then the lattice strain within the structure was calculated from changes in the phase value of the crystal plane.

FFT structure analysis was performed on the coating layer on the cathode active material of Example 1. The result shows that the layered crystal structure was formed at the \textcircled{1} and \textcircled{2} points and an amorphous structure was formed at the \textcircled{3} point area. That is, the \textcircled{1} point area preset in the inner direction is actually a part of the one-body core or a part of the composite coating layer very close thereto, and forms a crystalline coating part along with the \textcircled{2} point area. On the other hand, the \textcircled{3} point area present in the outer direction forms an amorphous coating part applied to the outer surface of the crystalline coating part. Therefore, the coexistence of the crystalline coating part and the amorphous coating part can be confirmed.

### <Experimental Example 5> Electrochemical Evaluation-1

A 2032 coin-type half-cell was produced using the cation active material synthesized in each of Examples 1 to 12 and Comparative Examples 1 to 9, electrochemical evaluation was performed.

Specifically, the cathode active material, polyvinylidene fluoride as a binder (KF1100), and Super-P as a conductive material were mixed at a weight ratio of 92:5:3, and the mixture was mixed with N-methyl-2-pyrrolidone as a solvent to prepare a cathode active material slurry. Then, aluminum foil (Al foil, thickness: 20 μm), which is a cathode current collector, was coated with the slurry, dried at 120° C., and then pressed to prepare a cathode plate. The loading level of the rolled cathode was 7 mg/cm² and the rolling density was 3.90 g/cm³. The cathode plate was punched to 14<D, and a 2032 coin-type half-cell was manufactured using lithium metal as an anode and an electrolyte (EC/DMC 1:1+1 mole of LiPF₆).

The manufactured coin-type half-cell was aged at room temperature for 10 hours, and then a charge-discharge test was performed thereon. Capacity test was based on 190 mAh/g at 0.1 C rate, and charge and discharge were performed under the conditions of constant current (CC)/constant voltage (CV) within a voltage range of 4.3 to 3.0V.

After measurement, the initial charge-discharge capacity and initial resistance are shown in Table 3 below.

In addition, the coin-type half-cell manufactured above was aged at room temperature for 10 hours and then HPPC (hybrid pulse power characterization) test was performed. The resistance was measured using the following equation based on the voltage difference obtained by pulsing the discharge current at 1 C in the SOC range of 90 to 10%, and the results are shown in Table 3.

Ω (resistance)=ΔV/I

TABLE 3

| | Charge | Discharge | | Initial | HPPC |
|---|---|---|---|---|---|
| | capacity | capacity | Efficiency | formation | SOC |
| Sample | (mAh/g) | (mAh/g) | (%) | resistance | 10% |
| Comparative | 224.8 | 199.7 | 88.83 | 55.5 | 45.5 |
| Example 1 | | | | | |
| Comparative | 226.4 | 201.3 | 88.91 | 60.4 | 48.2 |
| Example 2 | | | | | |
| Comparative | 235.5 | 208.4 | 88.49 | 70.5 | 51.3 |
| Example 3 | | | | | |
| Comparative | 229.5 | 206.5 | 90.00 | 44.4 | 34.5 |
| Example 4 | | | | | |
| Comparative | 228.5 | 204.6 | 89.54 | 62.5 | 49.3 |
| Example 5 | | | | | |
| Comparative | 237.0 | 209.5 | 88.40 | 72.5 | 50.3 |
| Example 6 | | | | | |
| Comparative | 224.0 | 194.7 | 86.90 | 38.7 | 39.3 |
| Example 7 | | | | | |
| Comparative | 226.5 | 199.2 | 87.95 | 40.2 | 40.5 |
| Example 8 | | | | | |
| Comparative | 228.9 | 202.1 | 88.29 | 45.9 | 41.2 |
| Example 9 | | | | | |
| Example 1 | 230.1 | 206.5 | 89.74 | 35.3 | 29.5 |
| Example 2 | 235.4 | 210.5 | 89.42 | 37.8 | 35.3 |
| Example 3 | 240.2 | 214.5 | 89.30 | 39.1 | 38.4 |
| Example 4 | 229.1 | 205.9 | 89.87 | 34.9 | 28.1 |
| Example 5 | 234.1 | 209.5 | 89.49 | 36.5 | 34.4 |
| Example 6 | 240.2 | 213.9 | 89.05 | 38.1 | 37.5 |
| Example 7 | 230.3 | 206.7 | 89.75 | 34.2 | 28.4 |
| Example 8 | 235.7 | 210.7 | 89.39 | 36.8 | 34.8 |
| Example 9 | 239.9 | 213.9 | 89.16 | 38.5 | 37.9 |
| Example 10 | 229.5 | 206.1 | 89.80 | 34.1 | 28.9 |
| Example 11 | 235.6 | 210.3 | 89.26 | 36.9 | 35.1 |
| Example 12 | 240.5 | 214.8 | 89.31 | 37.4 | 35.1 |

As can be seen from Table 3, when comparing Comparative Examples and Examples in terms of cathode active materials having the same Ni content, Examples 1 to 12 have high initial capacity and improved initial formation resistance compared to Comparative Examples 1 to 3 in which no coating layer is present and Comparative Examples 4 to 9 in which a single coating layer is present. This is because structural stabilization due to rearrangement of the surface structure, which is the effect of the crystalline coating part, and suppression of electrolyte side reactions, which is the effect of the amorphous coating part, are optimized, and the characteristics are overall improved when evaluating lithium secondary batteries.

In addition, it can be seen that the HPPC resistance of Examples 1 to 12 is reduced at SOC of 10% compared to Comparative Examples 1 to 3 and Comparative Examples 4 to 9. As described above, this is due to the effect of the composite coating layer of the crystalline coating part and the amorphous coating part present in the cathode active material.

### <Experimental Example 6> Electrochemical Evaluation-2

A 2032 coin-type half-cell was produced in the same manner as in Experimental Example 5 using the cation active material synthesized in each of Examples 1 to 3 and 7 to 12 and Comparative Examples 1 to 3 to determine lifespan characteristics, and the lifespan characteristics were determined at high temperature (45° C.).

The current conditions were 0.5 C charge/1.0 C discharge, 50 charge/discharge cycles were performed, and the ratio of 50^{th} discharge capacity to 1^{st} discharge capacity was obtained.

In addition, the rate of increase in high-temperature resistance (DC-IR, direct current internal resistance) is calculated by measuring the initial high-temperature resistance, measuring the resistance after 50 cycles, and converting the increase rate into a percentage (%). The result is shown in Table 4 below.

TABLE 4

| | High-temperature | High-temperature |
|---|---|---|
| | lifespan | resistance increase |
| Sample | 50 cyc % | A1-50% |
| Comparative Example | 95.6 | 28.8 |
| 1 | | |
| Comparative Example | 94.6 | 30.1 |
| 2 | | |
| Comparative Example | 93.5 | 36.1 |
| 3 | | |
| Example 1 | 97.6 | 15.2 |
| Example 2 | 96.9 | 20.2 |
| Example 3 | 95.3 | 25.1 |
| Example 7 | 97.4 | 14.2 |
| Example 8 | 96.5 | 22.0 |
| Example 9 | 95.8 | 26.5 |
| Example 10 | 97.7 | 9.5 |
| Example 11 | 96.8 | 11.5 |
| Example 12 | 95.7 | 12.6 |

As can be seen from Table 4, when comparing Comparative Examples and Examples in terms of cathode active materials with the same Ni content, Examples exhibited increased high-temperature lifespan compared to Comparative Examples 1 to 3 in which no coating layer was present, and an increased rate of high temperature resistance.

In particular, compared to Examples 2 to 9 including a crystalline/amorphous composite coating layer and being supplemented with B- and Co-based coating materials, Examples 10 to 12 including a crystalline/amorphous composite coating layer and being supplemented with a coating material containing W in addition to B and Co further suppressed an increase in high temperature resistance.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A cathode active material comprising:
a one-body core containing lithium transition metal oxide; and
a composite coating layer located on the one-body core,
wherein the composite coating layer comprises a crystalline coating part and an amorphous coating part.

2. The cathode active material according to claim 1, wherein the crystalline coating part improves initial resistance characteristics and lifespan characteristics through rearrangement of a surface structure, and
the amorphous coating part is applied to an entire remaining outer surface of the one-body particle core to suppress electrolyte side reactions due to contact with the one-body particle core.

3. The cathode active material according to claim 1, wherein the one-body core is a lithium transition metal oxide containing Ni and a content of Ni is 60 mol % or more based on a total content of the transition metal.

4. The cathode active material according to claim 1, wherein the one-body core comprises a composition of Formula 1 below:
LiₐNi_{b}Co_{c}Mn_{d}DₑOₓ (1)
wherein a, b, c, d, e and x satisfy 0.95≤a≤1.1, 0<b≤1, 0≤c<1, 0≤d<1, 0≤e≤0.05, and 0<x≤4, respectively, and
D includes at least one of Ti, Zr, Al, P, Si, B, W, Mg, and Sn.

5. The cathode active material according to claim 1, wherein the crystalline coating part is distributed in an island type on the outer surface of the one-body particle core.

6. The cathode active material according to claim 5, wherein the island-shaped area comprises only a crystalline coating part, or a combination of the crystalline coating part and the amorphous coating part.

7. The cathode active material according to claim 6, wherein a size of the crystalline coating part in the island-shaped area is larger than that of the amorphous coating part.

8. The cathode active material according to claim 1, wherein the crystalline coating part comprises a compound of transition metal whose outermost electron is located in a 3d orbital in the electron configuration among periodic table elements.

9. The cathode active material according to claim 8, wherein the transition metal comprises at least one selected from Co, Mn, Ti, and Zr.

10. The cathode active material according to claim 9, wherein the transition metal is Co.

11. The cathode active material according to claim 8, wherein the crystalline coating part comprises at least one of:
(i) transition metal oxide (a); and
(ii) lithium transition metal oxide (b1) and transition metal oxide (b2) produced by the reaction of the transition metal oxide (a) and lithium by-product.

12. The cathode active material according to claim 1, wherein the amorphous coating part comprises a compound of a metalloid or nonmetal (metalloid/nonmetal) whose outermost electron is located in a p orbital of the electronic configuration among periodic table elements.

13. The cathode active material according to claim 12, wherein the metalloid/nonmetal comprises at least one of boron (B), silicon (Si), and carbon (C).

14. The cathode active material according to claim 13, wherein the metalloid/nonmetal is boron (B).

15. The cathode active material according to claim 12, wherein the amorphous coating part comprises at least one of:
(i) a metalloid/non-metal compound (c);
(ii) a metalloid/non-metal oxide (d1) and lithium oxide (d2) produced by reaction of the metalloid/non-metal compound (c) and a lithium by-product; and
(iii) lithium metalloid/non-metal oxide (e) as an intermediate phase between the metalloid/nonmetal oxide (d1) and lithium oxide (d2).

16. The cathode active material according to claim 12, wherein the amorphous coating part further comprises a tungsten-based compound.

17. The cathode active material according to claim 16, wherein the amorphous coating part further comprises at least one of:
(i) tungsten-based compound (f); and
(ii) lithium tungsten oxide (g) produced by reaction of the tungsten-based compound (f) and a lithium by-product.

18. The cathode active material according to claim 16, wherein the tungsten-based compound is tungsten oxide.

19. The cathode active material according to claim 5, wherein the crystalline coating part comprises a transition metal and a metalloid/non-metal, and a content of the transition metal is higher than 50%.

20. The cathode active material according to claim 12, wherein the amorphous coating part comprises a metalloid/nonmetal and a transition metal, and a total content of the metalloids/nonmetal is higher than 50%.

21. The cathode active material according to claim 1, wherein the rearrangement of the surface structure converts an inert rock-salt structure of the surface into a structure allowing movement of lithium ions.

22. A secondary battery comprising the cathode active material according to claim 1.
